(19) United States
(12) Patent Application Publication
(10) Pub. No.: US 2025/0210633 A1
(43) Pub. Date: Jun. 26, 2025

(54) BIPOLAR ELECTRODE AND POWER STORAGE DEVICE

(71) Applicant: TOYOTA JIDOSHA KABUSHIKI KAISHA, Toyota-shi (JP)

(72) Inventor: Momoko PROCTER, Seto-shi (JP)

(73) Assignee: TOYOTA JIDOSHA KABUSHIKI KAISHA, Toyota-shi (JP)

(21) Appl. No.: 18/899,232

(22) Filed: Sep. 27, 2024

(30) Foreign Application Priority Data
Dec. 26, 2023 (JP) 2023-219078

(51) Int. Cl. H01M 4/36; H01M 4/02

(52) U.S. Cl. CPC H01M 4/366; H01M 2004/029

(57) ABSTRACT

In the bipolar electrode, a positive electrode active material layer, an electrode current collector, and a negative electrode active material layer are provided in this order, and the positive electrode active material layer includes a first positive electrode active material and a second positive electrode active material having a layered crystal structure, and the first positive electrode active material has a cation mixing ratio of 5.0% or less and an excess lithium ratio of less than 1.0% by mass, and the second positive electrode active material has a cation mixing ratio of 3.3% or less and an excess lithium ratio of less than 0.8% by mass.

### CROSS-REFERENCE TO RELATED APPLICATION

This application claims priority to Japanese Patent Application No. 2023-219078 filed on Dec. 26, 2023, incorporated herein by reference in its entirety.

### BACKGROUND

### 1. Technical Field

The present disclosure relates to a bipolar electrode and a power storage device.

### 2. Description of Related Art

Japanese Unexamined Patent Application Publication No. 2023-91566 (JP 2023-91566 A) discloses using two types of positive electrode active materials with different average particle diameters, with an objective of increasing a volume capacity density of a positive electrode of a nonaqueous electrolyte secondary battery.

### SUMMARY

In JP 2023-91566 A, while the volume capacity density of the positive electrode of the nonaqueous electrolyte secondary battery is improved, there is room for improvement from the viewpoint of resistance.

Here, a bipolar electrode (bipolar battery) is known that has a positive electrode active material layer on one surface of a current collector, and a negative electrode active material layer on another surface. A bipolar battery attracts attention from the viewpoint of an improvement of energy density, compared to a conventional nonaqueous electrolyte secondary battery.

However, since the bipolar electrode presses a positive electrode and a negative electrode at the same time, the positive electrode is not sufficiently pressed, and contact of the positive electrode active material deteriorates. Moreover, while the bipolar battery has current flowing in a thickness direction of the electrodes, when contact between positive electrode active materials or a positive electrode active material and a conductive material is insufficient, since a path in which current flows becomes complicated, is interrupted or the like, a problem occurs such as an increase in resistance or a deterioration in durability.

The objective of the present disclosure is to provide a bipolar electrode and a power storage device in which suppression of an increase in resistance and suppression of a deterioration in durability are both achieved.

One aspect of the disclosure provides a bipolar electrode. The bipolar electrode includes a positive electrode active material layer, an electrode current collector, and a negative electrode active material layer in an order of the positive electrode active material layer, the electrode current collector, and the negative electrode active material layer.
the positive electrode active material layer includes a first positive electrode active material and a second positive electrode active material each having a layered crystal structure,
the first positive electrode active material has a proportion of cation mixing that is 5.0% or less and a proportion of excess lithium that is less than 1.0 mass %, and
the second positive electrode active material has a proportion of cation mixing that is 3.3% or less and a proportion of excess lithium that is less than 0.8 mass %.

The positive electrode active material of the present technology includes a first positive electrode active material and a second positive electrode active material. The first positive electrode active material and the second positive electrode active material each have a proportion of cation mixing and a proportion of excess lithium that are within specific ranges. By mixing the positive electrode active materials, it is anticipated that suppression of an increase in resistance and suppression of a deterioration in durability are both achieved.

In the bipolar electrode,
the first positive electrode active material includes polycrystal particles, and
the second positive electrode active material includes single crystal particles.

In the bipolar electrode,
the bipolar electrode contains the first positive electrode active material and the second positive electrode active material in a mass ratio of 30:70 to 90:10.

Another aspect of the present disclosure provides a power storage device that includes a bipolar electrode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a bipolar electrode according to the present embodiment;

FIG. 2 is a schematic diagram showing an example of the positive electrode active material layer of the present embodiment;

FIG. 3 is a schematic diagram illustrating an example of the power storage device of the present embodiment;

FIG. 4 is a table showing the production conditions of the positive electrode active materials used in Examples and Comparative Examples;

FIG. 5 is a chart showing analytical results of positive electrode active materials used in Examples and Comparative Examples; and

FIG. 6 is a table showing sample configurations and evaluation results of Examples and Comparative Examples.

### DETAILED DESCRIPTION OF EMBODIMENTS

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure.

In this specification, when a compound is represented by a stoichiometric composition formula such as, for example, “LiCoO₂”, the stoichiometric composition formula is exemplary only. For example, when lithium cobalt oxide is expressed as “LiCoO₂”, unless otherwise specified, the lithium cobalt oxide is not limited to a composition ratio of “Li/Co/O=1/1/2”, and can include Li, Co, and O in any composition ratio. The composition ratio may be non-stoichiometric.

As used herein, “D50” refers to a particle size that is 50% integrated in a volume-based particle size distribution (integrated distribution). The particle size distribution can be measured by laser diffraction methods.

In the present specification, at least one of the first positive electrode active material and the second positive electrode active material may be collectively referred to as a “positive electrode active material”.

### Bipolar Electrode

The bipolar electrode of the present embodiment is used as an electrode of a power storage device. The power storage device is, for example, a nonaqueous electrolyte secondary battery such as a lithium ion secondary battery. In the present embodiment, a bipolar electrode used in a lithium ion secondary battery will be described.

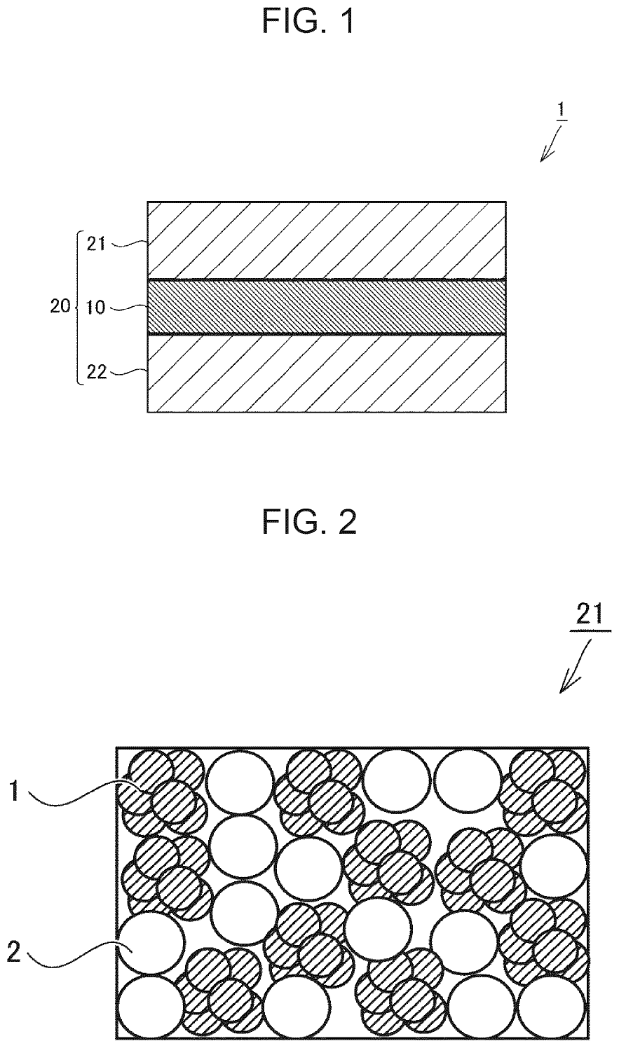

FIG. 1 is a schematic diagram illustrating an example of a bipolar electrode according to the present embodiment. The bipolar electrode 20 includes a positive electrode active material layer 21, an electrode current collector 10, and a negative electrode active material layer 22 in this order. That is, the positive electrode active material layer 21 is bonded to one main surface of the electrode current collector 10, and the negative electrode active material layer 22 is bonded to the other main surface.

### Positive Electrode Active Material Layer

FIG. 2 is a schematic diagram illustrating an example of the positive electrode active material layer of the present embodiment. The positive electrode active material layer 21 includes a positive electrode active material. The positive electrode active material includes a first positive electrode active material 1 and a second positive electrode active material 2. The first positive electrode active material 1 and the second positive electrode active material 2 each have a layered crystal structure. The positive electrode active material can be identified by, for example, Inductively Coupled Plasma Atomic Emission Spectroscopy (ICP-AES).

### Positive Electrode Active Material

The positive electrode active material of the present embodiment can absorb and release lithium ions reversibly. The positive electrode active material is a positive electrode active material containing a lithium metal-containing composite oxide. The positive electrode active material of the present embodiment may be a positive electrode active material made of a lithium metal-containing composite oxide. The lithium-metal-containing complex oxide may be, for example, at least one selected from the group consisting of LiCoO₂, LiNiO₂, LiMnO₂, Li(NiCoMn)O₂, and Li(NiCoAl)O₂. Among them, Li(NiCoMn)O₂ is preferable because the resistive property is particularly excellent. Such a lithium metal-containing composite oxide preferably has a composition represented by the following formula (i). The first positive electrode active material 1 and the second positive electrode active material 2 may have the same composition or different compositions. The chemical composition of the positive electrode active material can be measured by, for example, ICP-AES or the like.

Li_{z}Ni_{1-x-y}CoₓMn_{y}O₂ (i)

In the above equation (i), x, y and z satisfy the relationship of 0.1≤x≤0.4, 0.1≤y≤0.5, 0.95≤z≤1.2.

### First Positive Electrode Active Material

The first positive electrode active material 1 is polycrystal particles. In the present embodiment, the term “polycrystal particles” means that particles (secondary particles) formed by aggregation of 11 or more primary particles are contained in a scanning electron microscope image (SEM image) of 5000 times by 90% or more. That is, in the present embodiment, the ratio of the polycrystal particles contained in the first positive electrode active material 1 is 90% or more. The polycrystal particles may be formed, for example, by aggregation of 50 or more primary particles. In the polycrystal particles, there is no upper limit on the number of primary particles. The polycrystal particles may be formed, for example, by aggregation of 10000 or less primary particles, or may be formed by aggregation of 1000 or less primary particles.

The primary particles may have any shape. The primary particles may be, for example, spherical, columnar, lumpy, etc.

The polycrystal particles may have any shape. The polycrystal particles may be, for example, spherical, columnar, lumpy, or the like. The polycrystal particles may have, for example, a larger D50 than the single crystal particles described later. Thus, for example, a reduction in resistivity or the like is expected. D50 of the polycrystal particles may be, for example, 5 to 20 m or 15 to 19 m.

The crystallite diameter of the first positive electrode active material 1 may be 300 Å or more and 1100 Å or less. In the present embodiment, the “crystallite” refers to a region (collection) that can be regarded as a single crystal in a crystal structure in one particle constituting the positive electrode active material, and the “crystallite diameter” refers to the size of the crystallite. The crystallite diameter of the first positive electrode active material 1 is preferably 500 Å or more and 1000 Å or less.

The crystallite diameter of the positive electrode active material in the present embodiment can be calculated by Scherrer equation based on, for example, an X-ray diffractogram (X-ray Diffraction: XRD) pattern. The crystallite diameter of the positive electrode active material is obtained, for example, by calculating the half-width of the (003) plane found in the range of 20=19.1 to 20.1 in the spectrum obtained by measuring XRD using Scherrer equation.

The first positive electrode active material 1 has a cation mixing ratio of 5.0% or less. In the present embodiment, “cation mixing” indicates a state in which the lithium ion and the cation of the transition metal are replaced with each other in the crystal structure of the lithium metal-containing composite oxide. Alternatively, “cation mixing” refers to a state in which a cation of a transition metal occupies a lithium ion site in a crystal structure of a lithium metal-containing composite oxide.

When the proportion of the cation mixing is high, the cation of the transition metal substituted with the lithium ion prevents the passage of the lithium ion. As a result, it is considered that the stability of the crystal structure of the lithium metal-containing composite oxide is deteriorated, resulting in an increase in resistance and deterioration in durability. In the present embodiment, when the ratio of the cation mixing of the first positive electrode active material 1 is 5.0% or less, an increase in resistance and an improvement in deterioration in durability are expected. The proportion of the cation mixing of the first positive electrode active material 1 is preferably 4.0% or less. The cation mixing ratio of the first positive electrode active material 1 may be, for example, 0.5% or more, or 1.0% or more.

The ratio of the cation mixing in the present embodiment is calculated, for example, by performing a Rietveld analysis. The Rietveld analysis is a process for refining various parameters (lattice parameters, etc.) of the crystal structure so that the diffraction intensity calculated assuming the crystal structure model matches XRD pattern (diffraction intensity) measured by the powder XRD, etc. The diffracted peaks can be obtained by measuring the powder XRD using a XRD device.

The first positive electrode active material 1, the proportion of excess lithium is less than 1.0 mass %. In the present embodiment, “excess lithium” means lithium other than a lithium metal-containing composite oxide which is a positive electrode active material and which is present on the surface of the positive electrode active material. Specifically, the positive electrode active material contained in the positive electrode active material layer 21 is produced by reacting a lithium compound (precursor) such as lithium carbonate or lithium hydroxide with another material, as will be described later. When such a positive electrode active material is produced, in order to appropriately react a precursor with another material, a precursor is charged in excess, and an unreacted precursor may be contained in the produced positive electrode active material. Such a lithium compound contained in an unreacted state is referred to as “excess lithium”.

When the ratio of the excess lithium is high, it is considered that the excess lithium itself becomes a resistance layer, decomposition of the excess lithium occurs, and as a result, the resistance is increased and the durability is deteriorated. In the present embodiment, when the proportion of excess lithium in the first positive electrode active material 1 is less than 1.0 mass %, an increase in resistance and an improvement in deterioration in durability are expected. The proportion of excess lithium in the first positive electrode active material 1 is preferably 0.9% or less.

The proportion of excess lithium in the present embodiment can be measured, for example, by adding a predetermined amount of a positive electrode active material to pure water, stirring for a predetermined period of time, and then neutralizing and titrating the mass of lithium eluted in pure water with hydrochloric acid.

### Second Positive Electrode Active Material

The second positive electrode active material 2 is a single crystal particle. In the present embodiment, the term “single crystal particles” means that the sum of particles present alone and aggregates formed by aggregation of two or more and ten or less particles in a SEM image at a magnification of 5000 times is 80% or more. That is, in the present embodiment, the proportion of the single crystal particles contained in the second positive electrode active material 2 is 80% or more.

The single crystal particles in the present embodiment are grains whose grain boundaries are not visible in cross-sectional SEM images. The single crystal particles may have any shape. The single crystal particles may be, for example, spherical, columnar, lumpy, or the like.

The crystallite diameter of the second positive electrode active material 2 may be 800 Å or more and 1500 Å or less. In the present embodiment, the crystallite diameter of the second positive electrode active material 2 is preferably larger than the crystallite diameter of the first positive electrode active material 1. The crystallite diameter of the second positive electrode active material 2 is preferably 1000 Å or more and 1400 Å or less.

The second positive electrode active material 2 has a cation mixing ratio of 3.3% or less. When the proportion of the cation mixing of the second positive electrode active material 2 is 3.3% or less, an increase in resistance and an improvement in deterioration in durability are expected. The proportion of the cation mixing of the second positive electrode active material 2 is preferably 2.9% or less. The proportion of the cation mixing of the second positive electrode active material 2 may be, for example, 0.2% or more, or may be 0.5% or more.

The second positive electrode active material 2 has a proportion of excess lithium of less than 0.8 mass %. When the proportion of excess lithium in the second positive electrode active material 2 is less than 0.8 mass %, an increase in resistance and an improvement in deterioration in durability are expected. The proportion of excess lithium in the first positive electrode active material 1 is preferably 0.6% or less.

### Content Ratio

The content ratio of the first positive electrode active material 1 and the second positive electrode active material 2 is, for example, 30:70 to 90:10 in the mass ratio (first positive electrode active material 1: second positive electrode active material 2). When the mass ratio of the first positive electrode active material 1 and the second positive electrode active material 2 is within the above range, it is expected to suppress an increase in resistance and a deterioration in durability. The mass ratio of the first positive electrode active material 1 to the second positive electrode active material 2 may be 40:60 to 80:20.

### Content

Content of the active material of the positive electrode active material layer 21, i.e., the total content of the first positive electrode active material 1 and the second positive electrode active material 2 relative to the total weight of the positive electrode active material layer 21, for example, may be 50 mass %, may be 80 mass %, may be 90 mass % or more, may be 95 mass % or more, it may be substantially 100 mass %.

### Other Ingredients

The positive electrode active material layer 21 may further include, for example, a conductive material, a binder, and the like. The conductive material may include, for example, acetylene black (AB). The binder may include, for example, PVDF or the like. The conductive material and the binder may be, for example, 0.1 mass % or more and 10 mass % or less with respect to the positive electrode active material layer 21.

### Preparation of Positive Electrode Active Material

The positive electrode active material is prepared, for example, by the following procedure. Sulfates such as Ni are prepared. The sulfate is dissolved in water to form an acidic aqueous solution. For example, nickel sulfate, cobalt sulfate, and manganese sulfate may be dissolved in water to form an acidic aqueous solution.

A reaction vessel is prepared. An ammonium ion feeder such as aqueous ammonia is added to the reaction vessel, and the mixture is stirred. An aqueous alkaline solution is prepared by adding a pH adjusting agent such as sodium hydroxide to the reactor while stirring. The acidic aqueous solution is added dropwise to the alkaline aqueous solution while pH of the reaction solution is controlled to be constant. Thereby, a precipitate can be formed. The precipitate is believed to contain a complex hydroxide (precursor). The precipitate is washed, filtered, and dried to form a dry matter.

The mixture is formed by mixing the dry compound and the lithium compound. The lithium compound may include, for example, lithium carbonate, lithium hydroxide, and the like. The mixture is subjected to a heat treatment (calcination) to synthesize a lithium metal-containing composite oxide powder. A positive electrode active material is prepared by crushing the synthesized lithium metal-containing composite oxide powder.

In the present embodiment, a positive electrode active material having a desired cation mixing ratio and an excess lithium ratio can be prepared by appropriately adjusting a firing temperature, a firing time, and the like.

### Electrode Current Collector

The electrode current collector 10 may include, for example, at least one selected from the group consisting of aluminum (Al), stainless steel, nickel (Ni), chrome (Cr), platinum (Pt), niobium (Nb), iron (Fe), titanium (Ti), copper (Cu), and zinc (Zn). The electrode current collector 10 may be formed by plating the surface of a metal foil.

### Negative Electrode Active Material Layer

The negative electrode active material layer 22 includes a negative electrode active material. The negative electrode active material may include, for example, at least one selected from the group consisting of graphite, soft carbon, and hard carbon. The negative electrode active material layer may further include, for example, a binder, a thickener, and the like. Examples of the binder include styrene butadiene rubber (SBR) and the like. Examples of the thickener include carboxymethyl cellulose (CMC) and the like.

### Power Storage Device

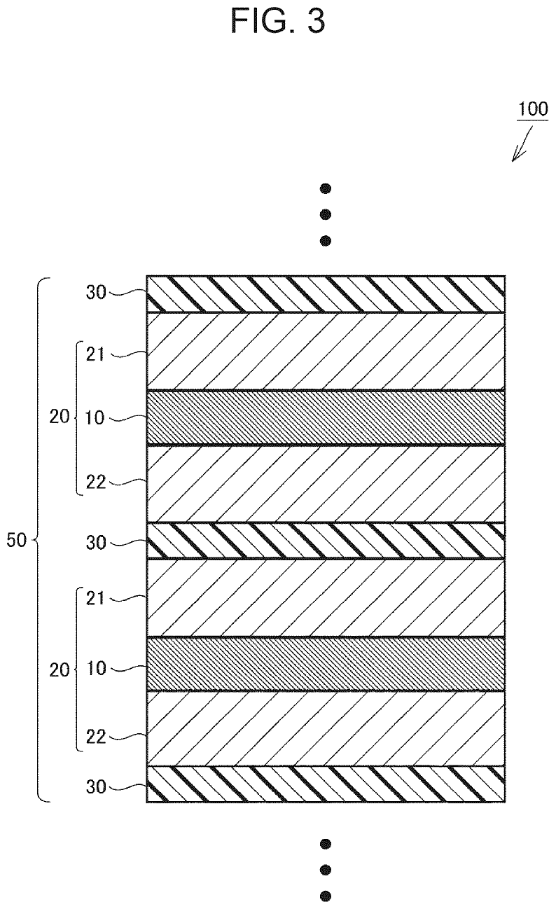

FIG. 3 is a schematic diagram illustrating an example of the power storage device of the present embodiment. In the present embodiment, a case where the power storage device 100 is a lithium ion secondary battery (hereinafter, may be abbreviated as a “battery”) will be described.

The battery 100 may include an exterior body (not shown). The exterior body may house the power generation element 50 and an electrolyte (not shown). The sheath may have any form. The exterior body may be, for example, a metal case or a pouch made of a metal foil laminate film. The outer casing may include, for example, an Al or the like.

The battery 100 includes a power generation element 50. The power generation element 50 may also be referred to as an electrode body or an electrode group. The power generation element 50 includes a bipolar electrode 20 and a separator 30. By alternately laminating the bipolar electrode 20 and the separator 30, the power generation element 50 can be formed.

### Separator

The separator 30 is porous. The separator 30 may pass through the electrolytic solution. The separator 30 separates the positive electrode active material layer 21 and the negative electrode active material layer 22. The separator 30 is electrically insulating. The separator 30 may include, for example, a polyolefin-based resin such as polyethylene (PE) or polypropylene (PP). The separator 30 may have, for example, a single-layer structure or a multi-layer structure. The separators 30 may consist of, for example, substantially PE layers, and may be formed by laminating PP layers, PE layers, and PP layers in this order.

### Electrolytic Solution

The electrolyte solution includes solvents and Li salts. The solvent is aprotic. The solvent may contain any component. The solvents may include, for example, at least one selected from the group consisting of ethylene carbonate (EC), dimethyl carbonate (DMC), and ethyl methyl carbonate (EMC).

Li salt is a supporting electrolyte. Li salt is dissolved in a solvent. Li salt may include, for example, at least one selected from the group consisting of LiPF₆ and LiBF₄. Li salt may have a molar concentration of, for example, 0.5 mol/L or more and 2.0 mol/L or less.

The electrolyte solution may further contain an optional additive. The electrolytic solution may contain, for example, 0.01% by mass or more and 5% by mass or less of an additive. The additive may include, for example, at least one selected from the group consisting of vinylene carbonate (VC), vinyl ethylene carbonate (VEC), and the like.

### Production of Positive Electrode Active Material

### No. A

Acidic aqueous solutions were obtained by dissolving nickel sulfate, cobalt sulfate, and manganese sulfate in ion-exchanged water. The molar ratio of Ni, Co and Mn in the aqueous acid solution was 8:1:1, and the concentration of the aqueous acid solution was 30% by mass.

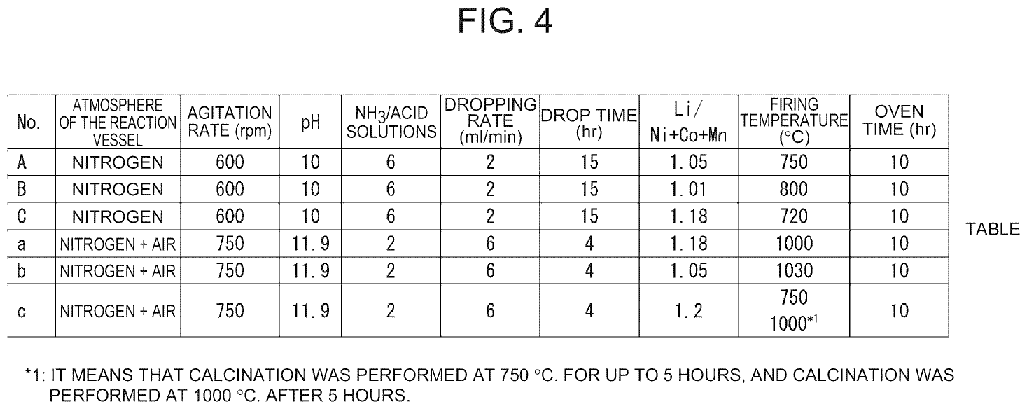

The reaction vessel was fed with ammonia water and stirred with a stirrer. Next, an aqueous alkaline solution was prepared by supplying an aqueous sodium hydroxide solution to the reaction vessel. While the aqueous alkali solution in the reaction vessel was stirred by the stirrer, the aqueous acid solution was added dropwise to the aqueous alkali solution. During the dropwise addition of the acidic aqueous solution, aqueous ammonia and aqueous sodium hydroxide were added as appropriate so that the ammonia level and pH of the reactant were constant. The precipitate after the reaction was washed with water and filtered to obtain a composite hydroxide. The resulting composite hydroxide was dried at 120° C. for 16 hours to obtain a dried product. In the above reaction, the atmosphere of the reaction vessel, the agitation rate, pH of the reaction solution, the mixing volume ratio of ammonia-water to the acidic solution (NH₃/acidic solution), the dropping rate of the acidic solution, and the dropping times are as shown in FIG. 4.

The dried product and lithium carbonate were mixed in a mortar to obtain a mixture. The mixture was calcined in a muffle furnace under an oxygen atmosphere to obtain a lithium metal-containing composite oxide powder. A No. A positive electrode active material was obtained by crushing the lithium-metal-containing complex oxide powder using a jet mill. The mixed molar ratio of Li to Ni, Co, and Mn in the dry matter (Li/Ni+Co+Mn), calcination temperature and calcination time are as shown in FIG. 4.

No. B to C, No. a to c

Except that the manufacturing conditions were changed as shown in FIG. 4, a positive electrode active material of c was obtained from No. B to C and No. a to c by the same process as that of No. A. It is to be noted that each positive electrode active material of C from No. A is a first positive electrode active material (polycrystal particles) and each positive electrode active material of c from No. a is a second positive electrode active material (single crystal particles), which was confirmed by SEM images (magnification: 5000×).

### Composition

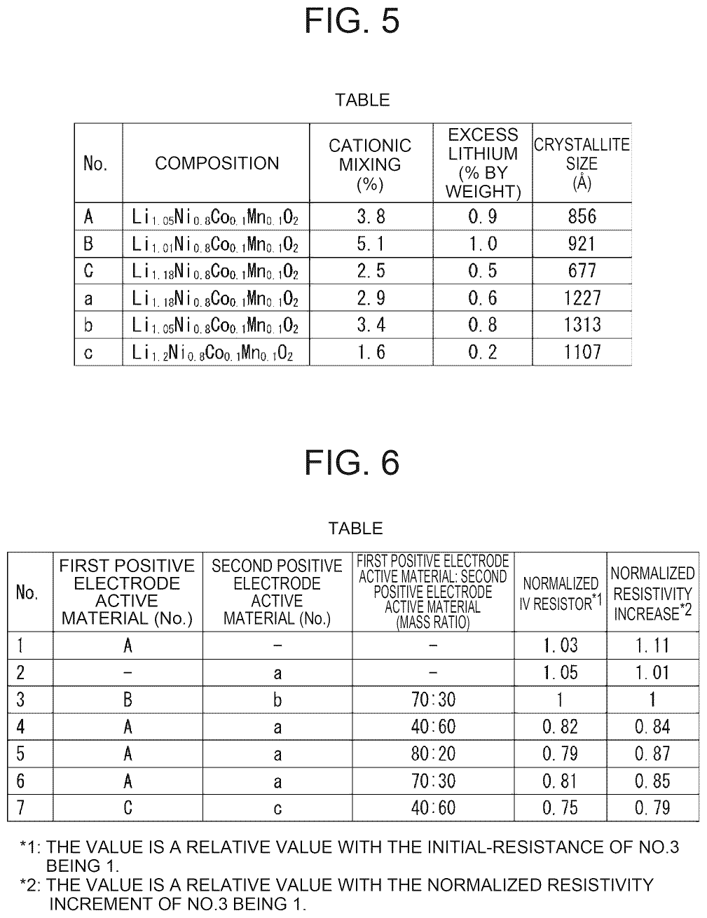

A ICP emission spectrometer (PS3520UVDD, manufactured by Hitachi High-Tech Science Co., Ltd.) was used to confirm the composition of the positive electrode active materials of the respective No. The results are shown in FIG. 5. In addition, the crystal structure of the respective No. was confirmed to have a layered crystal structure in any of the positive electrode active materials.

### Cation Mixing

A XRD device (manufactured by Rigaku Co., Ltd., Smartlab) was used to irradiate the positive electrode active materials of the respective No. with X-rays under the following conditions to obtain a XRD pattern. From the obtained XRD pattern, the crystalline peak data was subjected to Rietveld analysis, and the ratio of the cationic mixing of the positive electrode active materials of the respective No. was calculated. The results are shown in FIG. 5.

### Measurement Conditions

X-ray power: 45 kV, 200 mA
X-ray source: CuK α ray (wavelength: 1.54051 Å), single crystal monochromator
Diffraction angle: 10° to 120°
Temperature: room temperature (25° C.)
Scan speed: 1 sec/step

### Excess Lithium

The positive electrode active material of the respective No. of 1 g was added to pure water and stirred for 30 minutes, and then the mass of lithium eluted in pure water was neutralized and titrated with hydrochloric acid to calculate the proportion of excess lithium. The results are shown in FIG. 5.

### Crystallite Size

The crystallite diameter of the positive electrode active material of the respective No. was calculated by calculating the half-width of the (003) plane found in the range of 20=19.1 to 20.1 in the spectrum obtained under the above-described measuring conditions by Scherrer equation. The results are shown in FIG. 5.

Manufacture of Lithium-Ion Secondary Batteries

As a material of the positive electrode active material layers, the positive electrode active materials from No. A to C and No. a to c, AB (Denka Co., Ltd.) as a conductive material, and PVdF (Kureha Co., Ltd.) as a binder were prepared. A positive electrode active material layer was prepared using the above-described material. The mass ratio of each material in the positive electrode active material layer is as follows: positive electrode active material (first positive electrode active material and second positive electrode active material): conductive material: binder=90:5:5. The mass ratio between the first positive electrode active material and the second positive electrode active material is shown in FIG. 6.

As a material of the negative electrode active material layer, natural graphite (Hitachi Chemical Co., Ltd.) as a negative electrode active material, and SBR (JSR Co., Ltd.) as a binder, and CMC (Nippon Paper Industries Co., Ltd.) as a thickener were prepared. A negative electrode active material layer was prepared using the above-described material. The mass ratio of each material in the negative electrode active material layer is as follows: negative electrode active material: binder: thickener=95:2.5:2.5.

An Al foil (thickness: 15 μm) was prepared as an electrode current collector. The positive electrode active material layer, the electrode current collector, and the negative electrode active material layer were laminated in this order, thereby producing a bipolar electrode.

As separators, a porous resin (PP/PE/PP) (thickness: 24 μm) in which PP layers were laminated on both sides of a PE layer was prepared. A bipolar electrode, a separator, and a bipolar electrode were laminated so that the separator separated the positive electrode active material layer and the negative electrode active material layer. Thus, an electrode body was formed.

As an exterior body, a pouch made of a laminate film was prepared. The electrode body was housed in the outer casing. As an electrolyte solution, a mixed solvent containing EC, a DMC, and EMC was prepared by dissolving a support salt (LiPF₆) at a 1 mol/L level. The electrolyte solution was injected into the exterior body. After the injection of the electrolyte solution, the outer casing was sealed. From the above, test batteries for evaluating were manufactured from No. 1 to 7. The first positive electrode active material and the second positive electrode active material used in the respective No. are shown in FIG. 6.

### Evaluation

### Normalized IV Resistor

State of Charge (SOC) of the test cell was adjusted to 50% by constant current-constant voltage (CC-CV) charge at 25° C. The current at constant current (CC) charge was 1 It. “1 It” is defined as the current at which the rated capacity of the cell is cut off in one hour. At a SOC of 50%, the cell was 3.7 V. After adjusting SOC, the cell was discharged at a 10 It current for 10 seconds with a 30-minute pause in between. Initial discharging resistance (normalized IV resistance) was obtained by the following equation (ii). The results are given in FIG. 6. The initial resistance in FIG. 6 is a relative value. No. 3 initial resistance is defined as 1.

$$R = ( {V}_{0} - {V}_{10} ) / current \qquad ( ii )$$

In the above formulae (ii), r represents a discharging resistor. The V₀ indicates a voltage at the beginning of discharging. The V₁₀ indicates a voltage when 10 seconds have elapsed from the beginning of discharging.

### Resistance Increase

After measuring the initial resistivity, SOC of the cell was adjusted to 80% by CC-CV charge at 25° C. The current during CC charge was 1 It. After adjusting SOC, cycling tests were performed at 25° C. That is, the following discharges and charges were alternately repeated for 15 days.
Discharge: Current=1 It, discharge capacity=capacity corresponding to 20% SOC
Charging: Current=1 It, charge capacity=capacity corresponding to 20% SOC

After the cycle test, the discharge resistance after the cycle (post-cycle resistance) was measured in the same manner as the initial resistance. The resistance increase rate (percentage) was determined by dividing the resistance after cycling by the initial resistance. The results are given in FIG. 6. The resistivity increase rate in FIG. 6 is a relative value. The resistivity of No. 3 is defined as 1.

### Results

As shown in FIG. 6, in No. 4 to 7, the normalized IV resistivity and the resistivity increasing rate are lower than in No. 1 to 3. In other words, in No. 4 to 7, it can be seen that both suppression of increased resistivity and suppression of deterioration of durability are achieved.

The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

What is claimed is:

1. A bipolar electrode that comprises a positive electrode active material layer, an electrode current collector, and a negative electrode active material layer in an order of the positive electrode active material layer, the electrode current collector, and the negative electrode active material layer, wherein:
the positive electrode active material layer includes a first positive electrode active material and a second positive electrode active material each having a layered crystal structure;
the first positive electrode active material has a proportion of cation mixing that is 5.0% or less and a proportion of excess lithium that is less than 1.0 mass %; and
the second positive electrode active material has a proportion of cation mixing that is 3.3% or less and a proportion of excess lithium that is less than 0.8 mass %.

2. The bipolar electrode according to claim 1, wherein:
the first positive electrode active material includes polycrystal particles; and
the second positive electrode active material includes single crystal particles.

3. The bipolar electrode according to claim 1, wherein the bipolar electrode contains the first positive electrode active material and the second positive electrode active material in a mass ratio of 30:70 to 90:10.

4. A power storage device that includes the bipolar electrode according to claim 1.
